(19) United States
(12) Patent Application Publication
(10) Pub. No.: US 2010/0309409 A1
(43) Pub. Date: Dec. 9, 2010

(54) LIGHT EMITTING ASSEMBLIES HAVING DEFINED REGIONS OF DIFFERENT BRIGHTNESS

(76) Inventors: Kurt R. Starkey, Strongsville, OH (US); Jeffery R. Parker, Richfield, OH (US); Fumitomo Hide, San Jose, CA (US)

Correspondence Address: Donald L. Otto (Rambus);Renner, Otto, Boisselle & Sklar, LLP, 1621 Euclid Avenue, 19th Floor, Cleveland, OH, 44115, US

(21) Appl. No.: 12/792,422

(22) Filed: Jun. 2, 2010

Related U.S. Application Data
(60) Provisional application No. 61/183,582, filed on Jun. 3, 2009.

(51) Int. Cl. G02F 1/1335; F21V 5/04

(52) U.S. Cl. 349/62; 362/311.01

(57) ABSTRACT

A light emitting assembly has a LED light source illuminated optical conductor having a pattern of well defined light extracting optical elements configured to redirect light from an LED light source out from the optical conductor. The optical elements are additionally configured to define elongate higher brightness regions on the major surface of the optical conductor, and a lower brightness region outside of the higher brightness regions.

### CROSS-REFERENCE TO RELATED APPLICATIONS

This application claims the benefit of U.S. Provisional Application Ser. No. 61/183,582, filed Jun. 3, 2009, the entire disclosure of which is incorporated herein by reference.

### BACKGROUND

Most liquid crystal display (LCD) apparatuses employ a light emitting assembly to provide backlighting for an LCD panel that functions as a light valve array. In conventional LCDs, fluorescent lamps, such as cold cathode fluorescent lamps (CCFLs), have been used as light sources in the light emitting assembly. The light emitting assembly is located behind the LCD panel, while the viewer is located in the front of the LCD panel. In this configuration, the light emitting assembly is also referred to as a backlight assembly. FIG. 1 is a schematic plan view of such a light emitting assembly 100 including fluorescent lamps 101, 103, 105, 107, and 109. The fluorescent lamps are shown extending across most of the width of the light emitting assembly and are held in place on their ends by frames 102, and 104 which also contain electrical connections for the fluorescent lamps.

A cross sectional schematic view of the light emitting assembly, taken along line 2-2 shown in FIG. 1, is shown in FIG. 2. FIG. 2 additionally shows the some other components of a conventional display apparatus. Fluorescent lamps 101, 103, 105, 107, 109 are mounted to in a light chamber 106. The fluorescent lamps emit light in all directions in the light chamber. The interior surface of the light chamber facing the fluorescent lamps has a reflective layer, film, or coating 108 that redirects the light from the fluorescent lamps towards a diffuser plate 110. The light passes through a light conditioning element. In the example shown, the light conditioning element is composed of diffuser plate 110, a diffuser film 112 and a prism film 114. Prism film 114 collimates the light in a preferred direction, e.g., a direction more normal to the surface of an LCD panel 111. The light is polarized by a polarizer film 113 before entering LCD panel 111 and then passes through another polarizer film 115 after leaving the LCD panel.

There has been increasing use of light emitting diodes (LEDs) as light sources in light emitting assemblies. One example of such a light emitting assembly is schematically shown in the top view shown in FIG. 3. FIG. 3 shows a generally planar optical conductor 130 with LEDs 132, 134, 136 positioned along one of its sides. A cross sectional schematic view of this light emitting assembly, taken along line 4-4, is shown in FIG. 4. LED 134 has a light emitting surface 135 which faces towards the light input surface 137 of the optical conductor 130. Light travels through the optical conductor by total internal reflection at the two major surfaces 141 and 143 of the optical conductor. In this case, a pattern of optical elements 140 is provided on or in the major surface 143 to extract light from the optical conductor. A reflecting sheet, film, or substrate 142 is located adjacent the major surface 143 to reflect light emitted from major surface back towards optical conductor 140. Such light is then emitted from the major surface 141. Additionally, diffuser films, diffuser plates, and prismatic films can be provided as described above with reference to FIG. 2. The light emitting assembly of FIGS. 3 and 4 is sometimes referred to as having a side-lit configuration because the LEDs are located on the side of the optical conductor. As noted above, one of the elements in the light emitting assembly is the pattern of optical elements 140 on or in the major surface 143. The optical elements vary in area density, number density, size, shape, height, and/or depth across the optical conductor to make the light emission uniform over the optical conductor.

### BRIEF DESCRIPTION OF THE DRAWINGS

FIG. 1 is a schematic plan view showing a conventional light emitting assembly that uses fluorescent lamps as light sources.

FIG. 2 is a schematic cross-sectional view showing the light emitting assembly of FIG. 1, taken along line 2-2 thereof.

FIG. 3 is a schematic plan view showing a conventional light emitting assembly that uses light emitting diodes as the light sources.

FIG. 4 is a schematic cross-sectional view showing the light emitting assembly of Fig.3, taken along line 4-4 thereof.

FIG. 5 is a schematic plan view showing an example of an optical conductor in accordance with an embodiment of the present invention.

FIG. 6 is a schematic cross-sectional view showing the optical conductor of FIG. 5, taken along line 6-6 thereof.

FIG. 7 is a schematic cross-sectional view showing another example of optical conductor in accordance with an embodiment of the present invention.

FIG. 8 is a schematic cross-sectional showing another example of an optical conductor in accordance with an embodiment of the present invention.

FIG. 9 is a cross-sectional view showing a portion of the optical conductor of FIG. 5, taken along line 9-9 thereof.

FIG. 10 is a cross-sectional view showing another example of an optical conductor in accordance with an embodiment of the present invention.

FIG. 11 is a cross-sectional view showing another example of an optical conductor in accordance with an embodiment of the present invention.

FIG. 12 is a schematic plan view showing another example of an optical conductor in accordance with an embodiment of the present invention.

FIG. 13 is a schematic plan view showing another example of an optical conductor in accordance with an embodiment of the present invention.

FIG. 14 is a schematic plan view of an LED light source.

FIG. 15 is a schematic cross-sectional view showing the LED light source of FIG. 14, taken along line 15-15 thereof.

FIG. 16 is a schematic plan view showing another example of an optical conductor in accordance with an embodiment of the present invention.

FIG. 17 is a schematic plan view showing another example of an optical conductor in accordance with an embodiment of the present invention.

FIG. 18 is a schematic plan view showing another example of an optical conductor in accordance with an embodiment of the present invention.

FIG. 19 is a schematic cross-sectional view showing a portion of the optical conductor of FIG. 18, taken along line 19-19 thereof.

FIG. 20 is a schematic plan view showing another example of an optical conductor in accordance with an embodiment of the present invention.

FIG. 21 is a schematic plan view showing another example of an optical conductor in accordance with an embodiment of the present invention.

FIG. 22 is a schematic cross-sectional view showing the optical conductor of FIG. 21, taken along line 22-22 thereof.

FIG. 23 is a schematic cross-sectional view showing two of the optical conductors shown in FIG. 22 arranged in tandem.

FIG. 24 is a schematic plan view showing a light emitting assembly composed of a 2-dimensional, 3×3 array of light emitting blocks.

FIG. 25 is a schematic plan view showing a light emitting assembly composed of light emitting blocks arrayed only in the X direction.

FIG. 26 is a schematic plan view showing a light emitting assembly composed of light emitting blocks arrayed only in the Y direction.

FIG. 27 is a schematic plan view showing a light emitting assembly composed of a 2-dimensional, 3×3 array of optical conductors.

FIG. 28 is a schematic perspective view of a LCD apparatus in accordance with an embodiment of the present invention.

FIG. 29 is a block diagram showing the drive circuitry for the thin film transistor array and light emitting blocks of the LCD apparatus shown in FIG. 28.

FIG. 30 is a more detailed block diagram showing the thin film transistor array shown in FIG. 29.

FIG. 31 is a block diagram comparing conventional backlighting to backlighting employing adaptive dimming.

FIG. 32 is a schematic timing chart showing the optical response of liquid crystal material in various rows of the LCD panel shown in FIG. 28 and the timing of the light emitting blocks of the backlight assembly.

### DETAILED DESCRIPTION

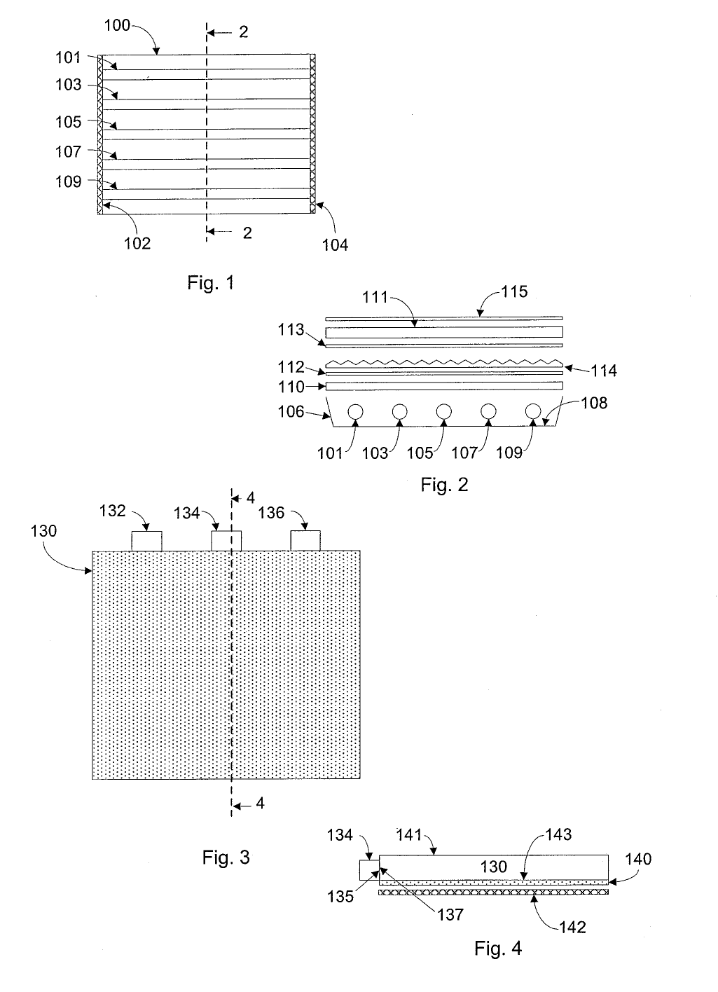

Designing the optical properties of an LED-illuminated light emitting assembly can be simplified by providing a LED illuminated optical conductor having a pattern of well defined light extracting optical elements that generate elongate higher brightness regions and lower brightness regions outside of the higher brightness regions. The higher brightness regions resulting from this approach resemble illumination profile of the conventional fluorescent lamp-based designs illustrated in FIGS. 1 and 2, and thus allow an LCD panel and light conditioning element designed for such conventional backlighting to be used with the LED-based light emitting assembly. However, the advantages of LED-based backlighting such as smaller size, wider color gamut, lower voltage operation, and faster response times, are also obtained.

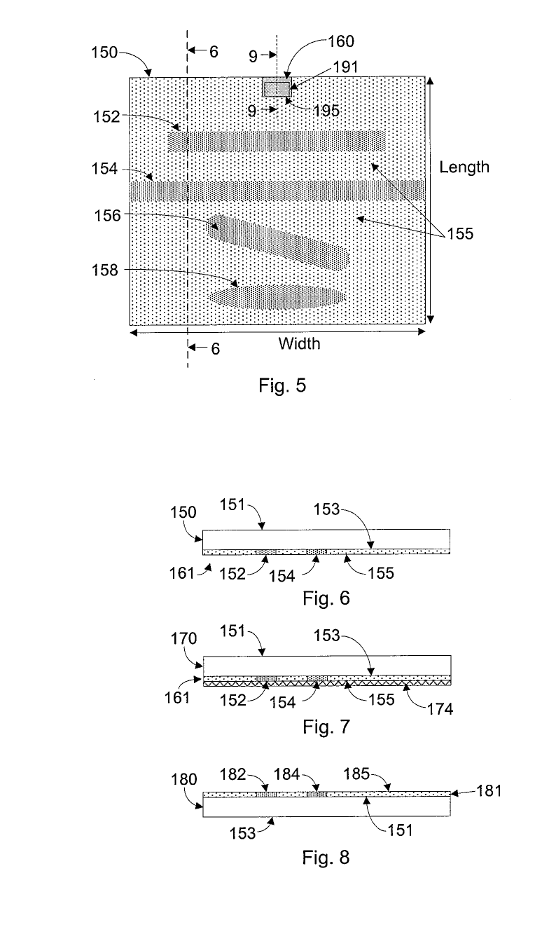

FIG. 5 is a schematic plan view showing a planar, rectangular optical conductor 150 in accordance with an embodiment of the present invention. The optical conductor 150 defines light source housing 160 adjacent one of its sides in which an LED light source 191 is housed. Optical conductor 150 has a front major surface 151 and a back major surface 153 opposite front major surface 151. When optical conductor 150 is arranged to illuminate an LCD panel (not shown), front major surface 151 faces the LCD panel and back major surface 153 is remote from the LCD panel.

Optical conductor 150 additionally has a pattern of well defined light extracting optical elements 161 on or in either or both of major surfaces 151 and 153 to direct light received from the LED light source out of the optical conductor. Examples of suitable well defined optical elements are described in U.S. Pat. No. 6,752,505, assigned to the assignee of this disclosure, the disclosure of which is incorporated by reference. The optical elements are small, and are typically very small, compared with the length and width of optical conductor 150. In an example, the optical elements have dimensions of the order of tens of micrometers, whereas optical conductor 150 has dimensions of the order of centimeters or tens of centimeters.

Light emitted by LED light source 191 illuminates optical conductor 150, and higher brightness regions become visible on the front major surface 151 of optical conductor 150. In the example shown, higher brightness region 152 is elongate, i.e., it has a significantly greater length component than width component, and is substantially rectangular in shape. In an example, the length of the higher brightness region is more than about 3 times its width. In another example, the length of the higher brightness region is more than about 10 times its width. Also shown is a higher brightness region 154 which, in addition to being elongate and substantially rectangular in shape, also extends across substantially the entire width or length of the optical conductor. Also shown are other examples of higher brightness regions, including a higher brightness region 156 in the shape of a rounded rectangle and a higher brightness region 158 in the shape of an ellipsoid or oval. A lower brightness region 155 is located outside the higher brightness regions. In the example shown, higher brightness region 155 surrounds higher brightness regions 152, 156 and 158, and is segmented by higher brightness region 154. The optical elements are configured in the lower brightness region to cause light to be emitted with a lower brightness than the higher brightness regions by having, for example, a lower area density.

A cross-sectional schematic view along line 6-6 in FIG. 5 is shown in FIG. 6. Optical conductor 150 has two major surfaces 151 and 153, and, in the example shown, a pattern of well defined light extracting optical elements 161 on or in the back major surface 153. The optical elements are configured to direct light out of optical conductor 150 such that the front major surface 151 exhibits higher brightness regions 152, 154, 156, 158 and a lower brightness region 155 when light from LED light source 191 (FIG. 5) illuminates optical conductor 150.

FIG. 7 is a cross sectional view showing another example of an optical conductor 170 having a reflective element 174 located adjacent a pattern of well defined light extracting optical elements 161 such that light refracted by the optical elements out from the optical conductor is reflected by reflective element 174 back towards the optical conductor. This light passes through the optical conductor and is emitted from the top major surface 151. Reflective element 174 is embodied as a reflective layer, sheet, film, or substrate.

FIG. 8 is a cross sectional view showing another example of an optical conductor 180 in which the pattern of well defined light extracting optical elements 181 that directs light out of optical conductor 180 is on or in the front major surface 151.

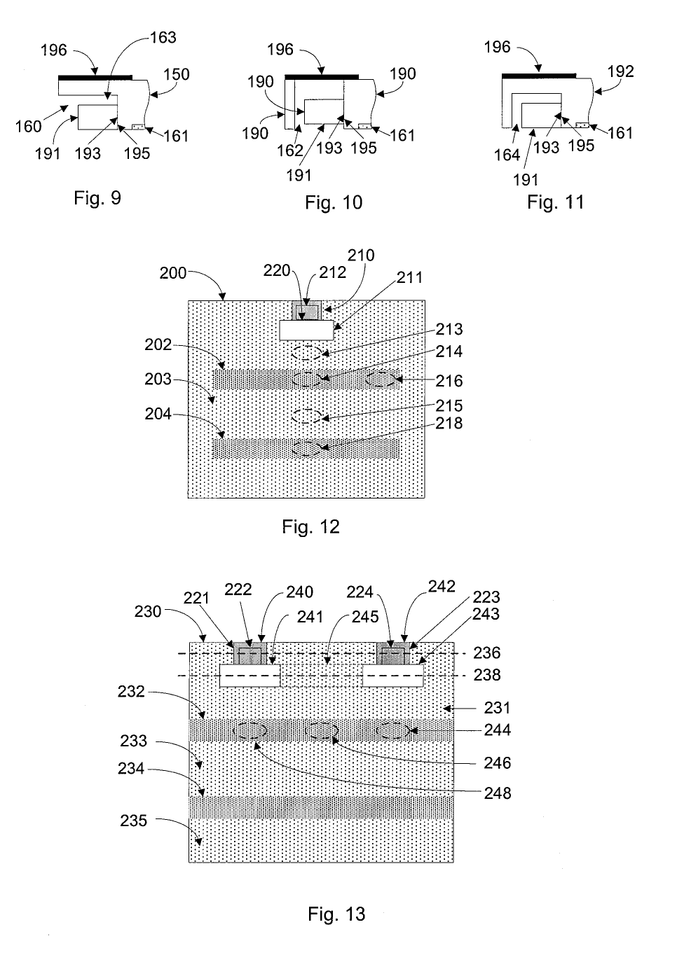

As noted above, optical conductor 150 shown in FIG. 5 defines light source housing 160 in which LED light source 191 is mounted. A cross sectional view taken along line 9-9 (FIG. 5) in this region of optical conductor 150 is shown in FIG. 9. In this example, light source housing 160 is configured as a recess 163 defined by optical conductor 150. The recess is accessible from the back major surface 153 and the side surface of the optical conductor. LED light source 191 is located in light source housing 160 such that its light emitting surface 193 faces the light input surface 195 of the optical conductor. The LED light source is electrically connected to a circuit board (not shown here) which may be located on or adjacent the back major surface 153 of the optical conductor. Light enters optical conductor 150 and some of that light is refracted or reflected by well defined light extracting optical elements 161. An opaque layer 196 is located on or in part of the front major surface 151 of optical conductor 150 adjacent light source housing 160 to block stray light from the LED light source. In an example, the opaque layer reflects light. In another example, the opaque layer absorbs light.

In an example of an optical conductor 190 shown in FIG. 10, the light source housing is configured as a hole 162 that extends between the major surfaces of the optical conductor. The arrangement of the LED light source otherwise is similar to that shown in FIG. 9.

In an example of an optical conductor 192 shown in FIG. 11, the light source housing is configured as a cavity 164 that extends into optical conductor 150 from the back major surface 153 thereof, and the LED light source 191 is located in the cavity. Alternatively, cavity 164 extends into optical conductor 192 from the front major surface 151 thereof. In an example, cavity 164 is configured as a slot, i.e., a cavity that is substantially longer and deeper than it is wide.

In the example shown in FIG. 5, the higher brightness regions 152 and 154 are nominally parallel to each other. Furthermore, in the example shown, higher brightness regions 152, 154 and 158 are nominally parallel to the light input surface 195 of optical conductor 150. Alternatively, the higher brightness regions may extend at an oblique angle to the light input surface, as is the case of higher brightness region 156. Furthermore, higher brightness region 156 extends at an oblique angle to the sides of the optical conductor.

FIG. 12 is a schematic plan view showing an example of an optical conductor 200 having a light source housing 210 in which is mounted an LED light source 212. The light source housing is defined in the optical conductor and is configured as recess, hole, slot, cavity or another shape suitable to accommodate LED light source 212. LED light source 212 mounted in light source housing 210 emits light towards a light input surface 220 of optical conductor 200.

Well defined light extracting optical elements (not individually shown) located on or in either or both of the major surfaces of optical conductor 200 direct light out from the optical conductor. The optical elements are configured to define higher brightness regions 202 and 204 and a lower brightness region 203 on the front major surface of the optical conductor.

In the embodiments described in this disclosure, the optical elements are configured by defining one or more of the area density, number density, size, depth, and height of the optical elements such that the higher brightness regions emit light with a higher intensity than the lower brightness region. The optical elements are typically additionally configured to provide one or both of a defined illumination pattern, such as a uniform illumination pattern, at least within the higher brightness regions, and a defined intensity relationship, such as an equal intensity relationship, at least between the higher brightness regions.

The optical elements are not necessarily uniform in one or more of area density, number density, size, depth, and height in higher brightness regions 202 and 204. Since higher brightness region 202 is closer to the LED light source 212 than higher brightness region 204, one or more of the area density, number density, size, depth, and height of the optical elements in a sub-region 218 of higher brightness region 204 is greater than in a sub-region 214 of higher brightness region 204. Moreover, within each of the higher brightness regions, one or more of the area density, number density, size, depth, and height of the optical elements is not necessarily uniform. For example, one or more of the area density, number density, size, depth, and height of the optical elements is greater in an off-axis sub-region 216 of higher brightness region 202 than in an on-axis sub-region 214 of higher brightness region 202. “Axis” refers to an axis defined by LED light source 212. Similarly, within the lower brightness region 203, one or more of the area density, number density, size, depth, and height of the optical elements is greater in a sub-region 215 further from LED light source 212 than in a sub-region 213 closer to the LED light source.

Additionally, in some embodiments, the brightness of an area adjacent the light input surface 220 of conductor 200 is controlled. Such region will be referred to herein as a controlled brightness region. In the example shown, a controlled brightness region 211 in which the area density of the optical elements is nominally zero is located adjacent light input surface 220. While the area density of the optical elements is nominally zero in controlled brightness region 211, the controlled brightness region may still be brighter than the surrounding lower brightness region 203 because of the proximity of the controlled brightness region to the light input surface. In the example shown, controlled brightness region 211 is rectangular in shape but other shapes, such as semicircles, trapezoids, and triangles are also possible. In embodiments in which the light emitted by LED light source 212 is diverging, controlled brightness region 211 is typically longer than the length of light input surface 220.

FIG. 13 is a schematic plan view showing an optical conductor 230 having light source housings 221 and 223 in which LED light sources 222 and 224, respectively, are mounted. Each light source housing 221, 223 is defined in optical conductor 230 and is configured as recess, hole, slot, cavity or another shape suitable to accommodate LED light source 222, 224. In the example shown, one LED light source is located in each light source housing, so that two LED light sources are coupled to the optical conductor 230. LED light source 222 mounted in light source housing 221 emits light towards a light input surface 241 of optical conductor 200 and LED light source 242 mounted in light source housing 223 emits light towards a light input surface 243.

A pattern of well defined light extracting optical elements (not individually shown) located on or in either or both of the major surfaces of optical conductor 230 directs light received at light input surfaces 241, 243 out from the optical conductor. The optical elements are configured to define higher brightness regions 232 and 234 and lower brightness regions 231, 233, and 235. Within higher brightness region 232, one or more of the area density, number density, size, depth, and height of the optical elements is greater in a sub-region 246, located approximately halfway between the LED light sources 222 and 224, than in sub-regions 244 and 248 aligned with LED light sources 222 and 224, respectively. Between sub-regions 244 and 248, one or more of the area density, number density, size, depth, and height of the optical elements is greatest approximately halfway between the LED light sources.

FIG. 13 also shows a first virtual line 236 along which LED light sources 222 and 224 are positioned. A controlled brightness region 241, 243, similar to controlled brightness region 211 described above with reference to FIG. 12, is associated with each LED light source 222, 224. FIG. 13 shows a second virtual line 238 along which controlled brightness regions 241 and 243 are located. A lower brightness region 245 is located between the controlled brightness regions along second virtual line 238. As described above, the brightness near controlled brightness regions 241 and 243 may be greater than in lower brightness region 245. By appropriately configuring the controlled brightness regions and the optical elements defining adjacent lower brightness region 245, the average brightness along second virtual line 238 can be controlled to a desired brightness, e.g., a brightness approximately equal to the brightness of higher brightness region 232 or higher brightness region 234. Features that can be optimized include one or more of the dimensions and shape of the controlled brightness regions, the area density, number density, size, depth and height of the optical elements in the lower brightness region, the distance between light source housings 221, 223, the brightness, dimensions, and light output distribution of the LED light source after passing through a microlens array (not shown). In some embodiments, the microlens array is part of, or mounted on, the LED light source, whereas in other embodiments, the microlens array is part of or mounted on the light input surface of the optical conductor. In this way, after the light has passed through a light conditioning element (not shown), such as one or more of, or multiple ones of, diffuser plate 110, diffuser sheet 112, and prism sheet 114 described above with reference to FIG. 2, that is optimized for use with conventional backlighting, a uniform illumination of the LCD panel (not shown) can be obtained.

The LED light sources in embodiments of the present invention typically have a light output distribution characterized by a greater width component than height component, where, when the light sources are mounted in their respective light source housings in the optical conductor, the height of the light output distribution is orthogonal to the front major surface of the optical conductor. An example of a suitable light source is a side-view type having a mounting face approximately orthogonal to the light emission direction.

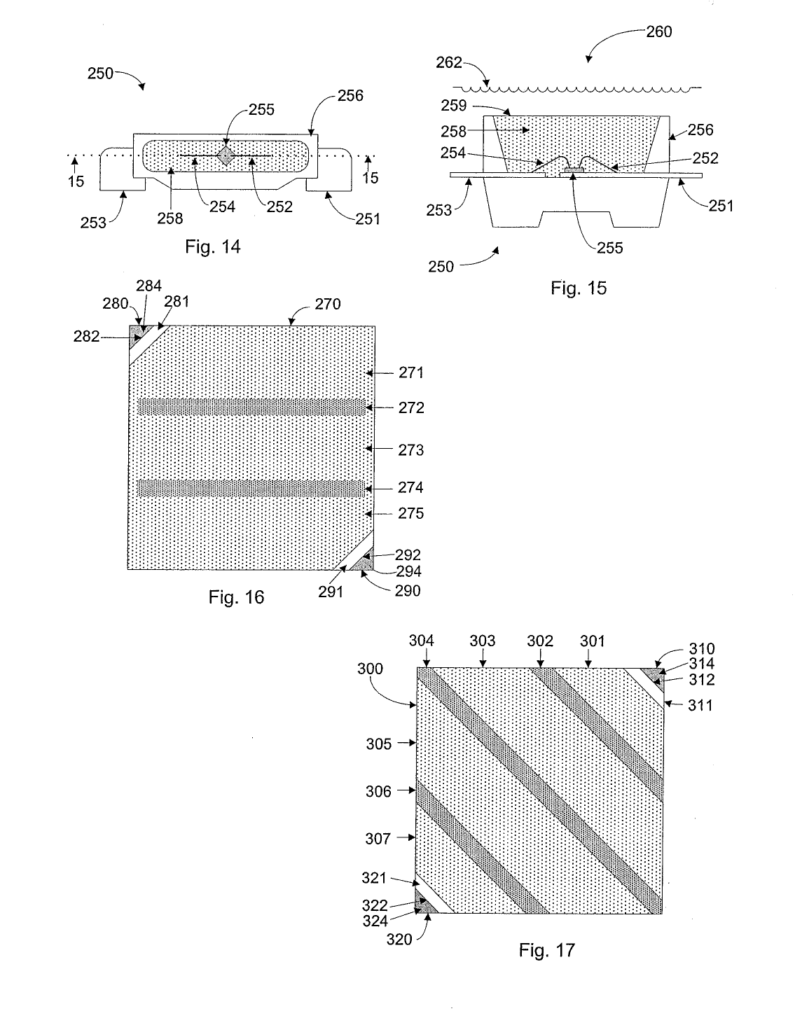

FIG. 14 is a schematic plan view showing an example of an LED light source 250 and FIG. 15 is a schematic cross sectional view taken along line 15-15 shown in FIG. 14. First and second plate-like leads 251, 253 are positioned such that their ends are adjacent, and an LED chip 255 is bonded to a surface of first lead 251 near its end adjacent second lead 253. The electrodes of the LED chip are electrically connected via wires 252, 254 to first and second leads 251, 253, respectively. In this example, the LED chip does not have a bottom electrode. First and second leads 251, 253 are fixed in position by a white resin body 256. The LED chip is located in the concave portion of resin body 256. The concave portion is filled with a transparent resin 258 through which light travels before it reaches a light output surface 259. In the case of a white LED light source, down-conversion material, such as a phosphor, is added to the transparent resin 258.

Additionally shown in FIG. 15 is a light input surface 260 of an optical conductor (not shown). The light input surface has a microlens array 262 located adjacent the light output surface 259 of the LED light source when the latter is mounted in or on the optical conductor. The microlens array couples and distributes the light from the LED light source into the optical conductor. For simplicity of illustration, the microlens array has been omitted from the other Figures that show a light input surface. However, the microlens array can be used beneficially in all of the embodiments shown.

FIG. 16 is a schematic plan view showing an example of an optical conductor 270 having a light source housing located adjacent at least one of its corners. A respective LED light source is mounted in each light source housing. In the example shown, a light source housing 280 is located at the upper left corner of the optical conductor in which a first LED light source 284 is mounted. The optical conductor has a light input surface 282 at an oblique angle to the sides of the optical conductor. Light source housing 280 is defined in optical conductor 270 and is configured as recess, hole, slot, cavity or another shape suitable to accommodate LED light source 284. LED light source 284 mounted in light source housing 280 emits light towards light input surface 282 of optical conductor 270.

Well defined light extracting optical elements (not individually shown) located on or in either or both of the major surfaces of optical conductor 270 direct light out from the optical conductor. The optical elements are configured to define the higher brightness regions 272 and 274 and the higher brightness regions are lower brightness regions 271, 273, and 275 surrounding the higher brightness regions.

Optionally, optical conductor 270 defines a second light source housing 290 located at the lower right-hand corner, diagonally opposite the light source housing 280. A second LED light source 294 is mounted in light source housing 290. Optical conductor 270 has a light input surface 292 also at an oblique angle relative to the sides of the optical conductor and to the higher brightness regions. Controlled brightness regions 281 and 291 are located adjacent the light input surfaces 282 and 292, respectively.

FIG. 17 is a schematic plan view showing another example of an optical conductor 300 having light source housings 310, 320 adjacent one or more corners in which respective LED light sources 314, 324 are mounted. Each light source housing 310, 320 is defined in optical conductor 300 and is configured as a recess, hole, slot, cavity or another shape suitable to accommodate LED light source 314, 324, respectively. The light source housings are defined at diagonally opposite corners of optical conductor 300. Each light source housing has at least one LED light source mounted therein. LED light source 314 mounted in light source housing 310 emits light towards a light input surface 312 of optical conductor 300 and LED light source 324 mounted in light source housing 320 emits light towards a light input surface 321.

A pattern of well defined light extracting optical elements (not individually shown) located on or in either or both of the major surfaces of optical conductor 300 directs light received at light input surfaces 311, 321 out from the optical conductor. The optical elements are configured to define higher brightness regions 302, 304, 306 interleaved with lower brightness regions 301, 303, 305 and 307. Higher brightness regions 302, 304, 306 and lower brightness regions 301, 303, 305 and 307 extend nominally parallel to the diagonal of optical conductor 300, and are at oblique angles to the sides of the optical conductor. The light input surfaces 311, 321 are approximately parallel to the higher brightness regions 302, 304, 306.

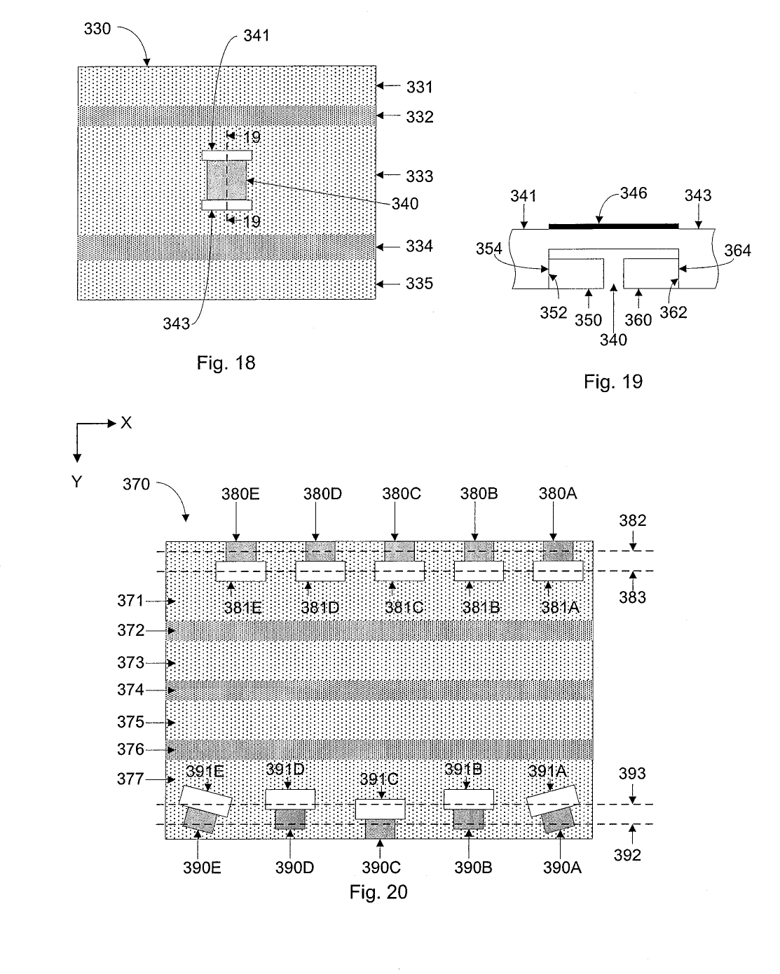

The LED light sources can be located in positions other than near an edge or corner of the optical conductor. For example, FIG. 18 is a schematic view showing an optical conductor 330 having a light source housing at a location offset from the sides of the optical conductor. In the example shown, a light source housing 340 is located near the center of the optical conductor. At least one LED light source (not shown in FIG. 18) is mounted in light source housing 340. A schematic cross sectional view along line 19-19 of FIG. 18 is shown in FIG. 19.

A pattern of well defined light extracting optical elements (not individually shown) located on or in either or both of the major surfaces of optical conductor 330 directs light out from the optical conductor. The optical elements are configured to define higher brightness regions 332, 334 interleaved with lower brightness regions 331, 333, 335. Higher brightness regions 332, 334 and lower brightness regions 331, 333, 335 extend nominally parallel to the sides of optical conductor 330.

Light source housing 340 is defined in the optical conductor 330 and is configured as recess, hole, slot, cavity or another shape suitable to accommodate one or more LED light sources. In the example shown, two LED light sources 350 and 360 are mounted in light source housing 340 and each LED light source emits light towards a respective light input surface 364, 364 of optical conductor 330. A controlled brightness region 341, 343 is located adjacent light input surface 354, 364, respectively. An opaque layer 346 is located adjacent light source housing 340 to block stray light.

LED light source 350 is mounted within light source housing 340 with its light output surface 352 facing light input surface 354. Light from LED light source 350 is directed primarily towards controlled brightness region 341 and higher brightness region 332. LED light source 360 is mounted within light source housing 340 with its light output surface 362 facing light input surface 364. Light from LED light source 360 is directed primarily towards controlled brightness region 343 and higher brightness region 334.

Light emitting assemblies that have more than one or two LED light sources are possible. FIG. 20 is a schematic plan view showing an example of an optical conductor 370 having multiple light source housings in each of which one or more LED light sources are mounted.

A pattern of well defined light extracting optical elements (not individually shown) located on or in either or both of the major surfaces of optical conductor 370 directs light out from the optical conductor. The optical elements are configured to define higher brightness regions 372, 374, 376 interleaved with lower brightness regions 371, 373, 375, 377. The higher brightness regions have approximately the same widths and are uniformly spaced from one another. Higher brightness regions 372, 374, 376 and lower brightness regions 371, 373, 375, 377 extend nominally parallel to the sides of optical conductor 370.

Along a first side of optical conductor 370 are defined five light source housings 380A-380E in each of which at least one LED light source is mounted. The LED light sources are not separately shown to simplify the drawing. Light source housings 380A-380E are located along a first virtual line 382. Respective controlled brightness regions 381A-381E are located adjacent light source housings 380A-380E arrayed along a second virtual line 383. Second virtual line 383 is parallel to the higher brightness regions. By adjusting the average brightness along second virtual line 383 and the distance of the second virtual line from adjacent higher brightness region 372, a more uniform illumination can be obtained after the light has passed through a light conditioning element (not shown) composed of one or more of, or multiple ones of, such optical films as a diffuser plate, a diffuser sheet, and a prism sheet. The average brightness depends at least on the number of LED light sources, the brightness of each LED light source, and the spacing between the LED light sources. The average brightness referred to here is the average of the brightness of the high brightness regions and in the other regions along second virtual line 383.

Additionally, along a second side of the optical conductor, opposite the first side, are defined five additional light source housings 390A-390E in each of which at least one LED light source is mounted. The LED light sources are not separately shown to simplify the drawing. Light source housings 390A-390E are located along a third virtual line 392. Respective controlled brightness regions 391A-391E are located adjacent light source housings 390A-390E arrayed along a fourth virtual line 393. However, light source housing 390A is oriented at an oblique angle relative to third virtual line 392 and its corresponding controlled brightness region 391A is oriented at an oblique angle relative to fourth virtual line 393. Additionally, light source housing 390E and its corresponding controlled brightness region 391E are oriented at an oblique angle to third and fourth virtual lines 392, 393, respectively. Light source housing 390C is offset in the Y direction relative to light source housings 390B and 390D, while controlled brightness region 391C is offset relative to controlled brightness regions 391B and 391D. This example shows that it is not necessary that the light source housings and controlled brightness regions have the same orientation and position in the Y direction.

FIG. 21 is a schematic plan view showing another example of an optical conductor 400 in accordance with an embodiment of the invention in which the elongate higher brightness regions are parallel to one side of the optical conductor and the light input surfaces are arrayed in a direction orthogonal to such side.

A pattern of well defined light extracting optical elements (not individually shown) located on or in either or both of the major surfaces of optical conductor 400 directs light out from the optical conductor. The optical elements are configured to define higher brightness regions 411, 413, 415, 417, 419 interleaved with lower brightness regions. Higher brightness regions 411, 413, 415, 417, 419 and the lower brightness regions extend nominally parallel to the sides of optical conductor 330.

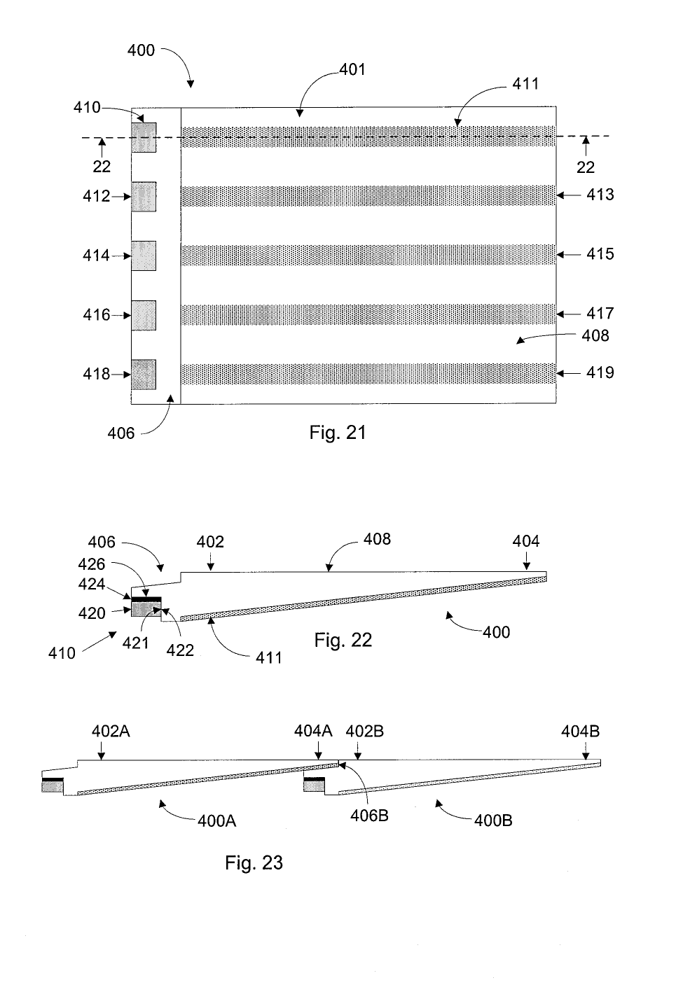

Along one side of optical conductor 400 are light source housings 410, 412, 414, 416, 418 in each of which at least one LED light source is mounted. Each light source housing 410, 412, 414, 416, 418 is located at one end of a respective one of higher brightness regions 411, 413, 415, 417, 419. FIG. 22 is a schematic cross sectional view taken along line 22-22 shown in FIG. 21. Light source housing 410 is defined in optical conductor 400 and is configured as recess, hole, slot, cavity or another shape suitable to accommodate one or more LED light sources. In the example shown, an LED light source 420 is mounted within light source housing 400. The remaining LED light sources are not individually shown in FIG. 21 to simplify the drawing. Light source housing 400 includes a surface 426 covered with an opaque layer 424 for blocking stray light. When a light emitting apparatus that includes optical conductor 400 is used to illuminate an LCD panel, surface 426 is interposed between LED light source 420 and the LCD panel.

In a plane orthogonal to its front major surface 408, optical conductor 400 has a tapered cross sectional shape that increases the fraction of the light emitted by the LED light sources mounted in light source housings 410-418 emitted from major surface 408 of optical conductor 400. Optical conductor 400 has a thickness in a direction orthogonal to major surface 408. The thickness decreases distally from light source housings 410, 412, 414, 416, 418, so that a distally-located thinner portion 404 of the optical conductor is thinner than a proximally-located thicker portion 402.

A proximal portion of major surface 408 of optical conductor 400 adjacent light source housings 410, 412, 414, 416, 418 includes a step that defines a recess 406. Recess 406 extends into the proximal portion 402 of optical conductor 400 from front major surface 408. Recess 406 will be further described with reference to FIG. 23, which is a cross sectional view showing two instances 400A, 400B of optical conductor 400 arranged in tandem with the distal portion 404A of optical conductor 400A accommodated within recess 406B in the proximal portion 402B of optical conductor 400B. By overlapping the distal portion 404A with the light source housings of adjacent optical conductor 400B, usable light emission area is maximized.

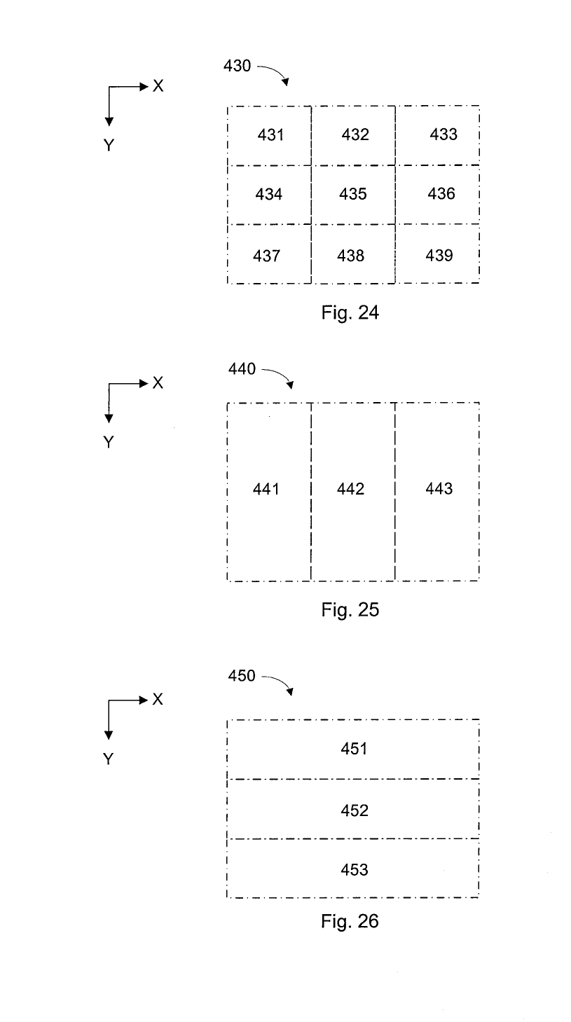

One or more optical conductors can be used to build a 1-dimensional or 2-dimensional array of light emitting blocks, with each light emitting block being selectively operable. FIG. 24 is a schematic plan view of a light emitting assembly 430 composed of a 2-dimensional, 3×3 array of light emitting blocks 431-439. FIG. 25 is a schematic plan view of a light emitting assembly 440 composed of light emitting blocks 441-443 arrayed only in the X-direction. FIG. 26 is a schematic plan view of a light emitting assembly 450 composed of light emitting blocks 451-453 arrayed only in the Y-direction.

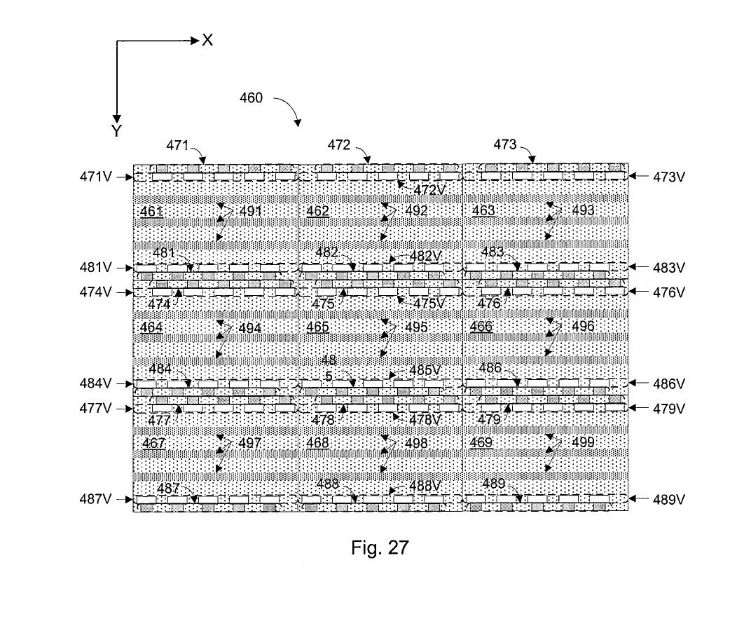

An example of a light emitting array based on the light emitting blocks shown in FIGS. 24-26 will be described with reference to FIG. 27. FIG. 27 is a schematic plan view showing a 2-dimensional, 3×3 array of optical conductors 461-469. A pattern of well defined light extracting optical elements (not individually shown) located on or in either or both of the major surfaces of each optical conductor directs light out from the optical conductor.. The optical elements are configured to define elongate higher brightness regions 491-499 interleaved with lower brightness regions. Higher brightness regions 491-499 and the lower brightness regions extend nominally parallel to the sides of the optical conductors. Defined in each optical conductor are light source housings 471-479 for LED light sources located along first side of the optical conductor. Also defined in each of the optical conductors are light source housings 481-489 for LED light sources located along a second side, opposite the first side, of the optical conductor. The LED light sources are not shown in FIG. 27 to simplify the drawing. Each optical conductor has a controlled brightness region corresponding to each light source housing. In the example shown, the higher brightness regions in each optical conductor are aligned with the higher brightness regions of the adjacent optical conductors in the X direction. However, in other examples, the higher brightness regions are not so aligned, the higher brightness regions do not extend substantially across the width or length of the optical conductor, or higher brightness regions that are adjacent in the X direction are offset staggered relative to each other in the Y direction. As described above, the light source housings (e.g., light source housings 471) are located along a first virtual line, and the corresponding controlled brightness regions are positioned along a second virtual line. Regions of varying brightness (471V-479V, 481V-489V) are composed of the controlled brightness regions and the lower brightness regions between adjacent controlled brightness regions. In the example shown, in each optical conductor, the spacing in the Y-direction between adjacent higher brightness regions is approximately equal, and the spacing in the Y-direction between the varying brightness region and the closest higher brightness region is approximately equal to the spacing between adjacent higher brightness regions.

The light source housings for the LED light sources of each optical conductor face away from and are offset in the X-direction from the light source housings for the LED light sources of the adjacent optical conductor. For example, optical conductor 461 has light source housings 481, and optical conductor 464 has light source housings 474. Light source housings 481 and 474 face away from each other and are offset from one another in the X direction.

The light emitting block arrangement shown in FIG. 24 can be implemented as follows. In the embodiment shown in FIG. 24, each light emitting block therein is provided by one of the optical conductors shown in FIG. 27 and its associated LED light sources (e.g., light emitting block 431 includes optical conductor 461, light emitting block 432 includes optical conductor 462, etc.). The LED light sources (not shown) mounted in the light source housings defined in each optical conductor are operated as an independent light emitting unit. In the embodiment shown in FIG. 25, each light emitting block is provided by three of the optical conductors shown in FIG. 27 and their associated LED light sources (e.g., light emitting block 441 includes optical conductors 461, 464, 467, etc.). To operate light emitting block 441, the LED light sources mounted in light source housings 471, 481, 474, 484, 477, and 487 are operated together. In the embodiment shown in FIG. 26, each light emitting block is provided by three of the optical conductors shown in FIG. 27 and their associated LED light sources (e.g., light emitting block 451 includes optical conductors 461, 462, 463, etc.). To operate light emitting block 451, the LED light sources mounted in light source housings 471-473 and 481-483 are operated together.

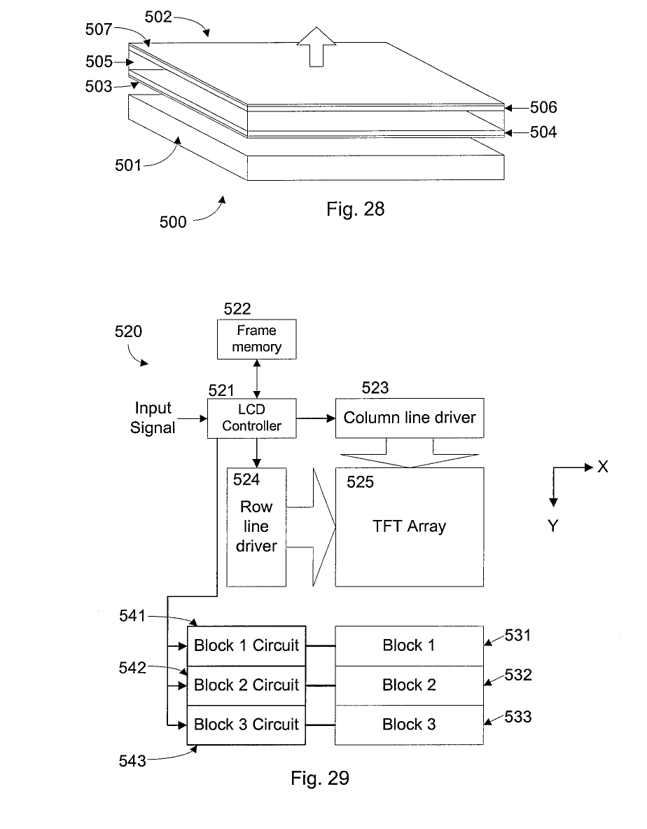

FIG. 28 is a schematic perspective view of a liquid crystal display apparatus in accordance with an embodiment of the present invention. The display apparatus 500 comprises a light emitting assembly 501 and a LCD panel 502. The light emitting assembly functions as a backlighting assembly and includes a light conditioning element (not shown) composed of such optical films as one or more of, or multiple ones of, a diffuser plate, a diffuser sheet, and a prism sheet, that increases the uniformity of the illumination provided to the LCD panel. The LCD panel 502 includes an active matrix substrate 504, a counter-substrate 506, and a liquid crystal layer 505 between them. The active matrix substrate typically includes an array of thin film transistors (TFTs), but thin film diodes (TFDs) have also been used, particularly for smaller displays. The color filter array is typically located on the counter-substrate, but color filter-on-array (CFA) technologies, in which the color filter array and TFT array are on the same substrate, are also available and can be used. In displays with field sequential drive, the color filter array is not used. Polarizers 503 and 507 are located on each substrate 504 and 506.

FIG. 29 is a block diagram showing an example of the drive circuitry 520 for TFT array 525 and light emitting blocks 531, 532, 533. In this example, the light emitting area of light emitting assembly 501 is divided in the Y direction into the light emitting blocks 531, 532, 533, which are similar to light emitting blocks 451, 452, 453 shown in FIG. 26. In drive circuitry 520, frame memory 522 is a memory device that temporarily stores one frame of pixel data. Each item of pixel data represents the intensity of the pixel controlled by a respective pixel circuit of TFT array 525. The pixel data stored in the frame memory is sent to the LCD controller 521. The LCD controller controls the operation of the entire LCD panel based on the pixel data from the frame memory and input signals from outside the block diagram.

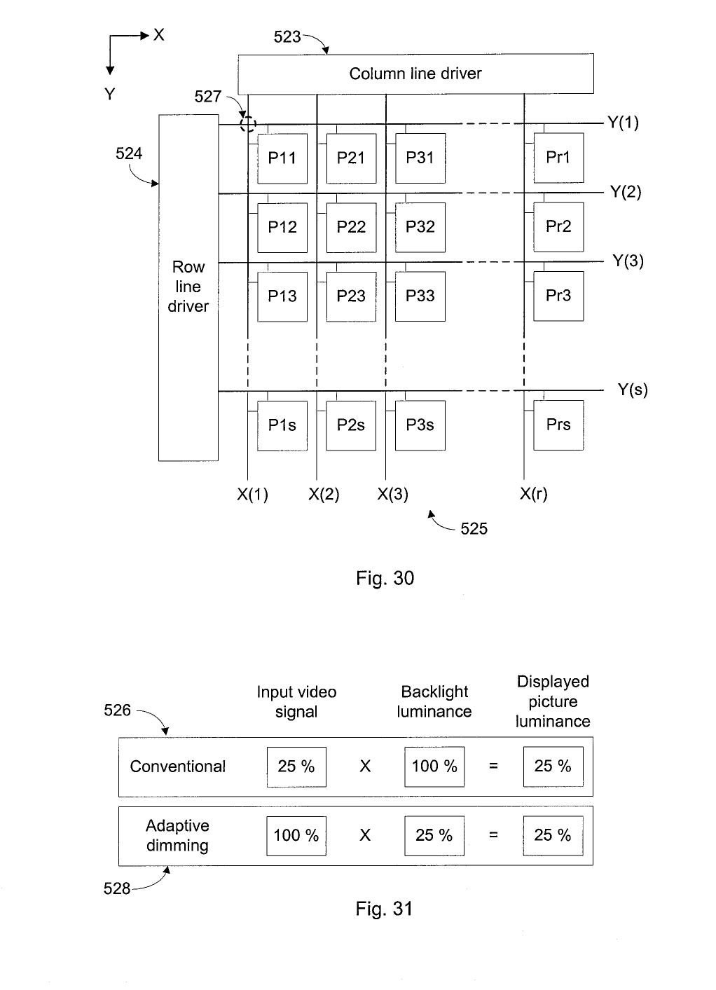

TFT array 525 is shown in greater detail in FIG. 30. Row lines Y(1) through Y(s) (where s is a positive integer that is a multiple of 3) extend in the X direction and are connected to a row line driver 524. The row driver sequentially imposes row select signals on the row lines. Column lines X(1) through X(r) (where r is a positive integer) extend in the Y direction and are connected to a column line driver 523. The column line driver sends the pixel data to the pixel circuits via the column lines. The column lines and row lines cross at cross points. For example, column line X(1) and row line Y(1) cross at cross point 527. A respective pixel circuit (P11-Prs) is located adjacent each cross point and is connected to the row line and the column line that cross at the cross point. For example, pixel circuit P11 is connected to row line Y(1) and the column line X(1) that cross at cross point 527. Each pixel circuit includes such elements as wiring, thin film transistors, and capacitors.

Row line driver 524 receives signals from LCD controller 524 and sequentially imposes row select pulses on row lines Y(1) through Y(s). Column line driver 523 receives the pixel data from the LCD controller and supplies the pixel data to the pixel circuits via the column lines. Each row select pulse causes the pixel data imposed by column line driver 523 on the column lines to be written to the pixel circuits in the row.

Light emitting block circuits 551, 552, 553 operate light emitting blocks (531, 532, 533) in response to light emitting block control signals received from the LCD controller. In the example shown in FIGS. 29 and 30, the LCD panel 502 is illuminated by three light emitting blocks of approximately the same size. Accordingly, a portion of LCD panel 502 including row lines Y(1) through Y(s/3) is illuminated by light emitting block 531, a portion including row lines Y(s/3+1) through Y(2s/3) is illuminated by light emitting block 532, and a portion including row lines Y(2s/3+1) through Y(s) is illuminated by light emitting block 533. In this example, the number of row lines (s) is an integral multiple of the number of light emitting blocks. However, the number of light emitting blocks and the dimensions of each light emitting block can be adjusted to accommodate any number of row lines. In the example shown in FIGS. 29 and 30, the light emitting blocks are arrayed in the Y direction. In another example, the light emitting blocks are arrayed in the X direction to obtain light emitting blocks shown, for example, in FIG. 25. Moreover, the light emitting can be arrayed in both the X and Y direction to obtain light emitting blocks shown, for example, in FIG. 24.

Using independently operable light emitting blocks enables the implementation of certain dynamic backlight techniques that provide localized, real-time control of backlight intensity in response to an incoming video data signal. One example is the adaptive backlight dimming illustrated in FIG. 31. In conventional backlighting 526, the backlight intensity is maintained at a prescribed value regardless of the intensity represented by the video data signal. With adaptive dimming 528, when the video data signal represents a low intensity, the input signal to the LCD panel is increased and the backlight intensity is decreased to give a displayed picture intensity that is substantially identical to that provided by conventional backlighting. The effective intensity of the backlighting can be reduced by reducing a current drive, a voltage drive, a current pulse duty cycle, a voltage pulse duty cycle, or another suitable drive parameter applied to the LED light sources optically coupled to the respective light emitting block. Adaptive dimming can be effective for reducing the electrical power consumption of the light emitting assembly, improving black level, and increasing the number of gray levels for low intensity images, thereby providing an effective bit depth (i.e., the number of levels in the grey scale) greater than the nominal bit depth of the LCD panel.

Adaptive dimming can be implemented in zero-, one- and two-dimensional (0D, 1D, and 2D) configurations. 0D-dimming means that the entire backlight is uniformly dimmed. 1D-dimming (line dimming) is suitable for use in displays backlit by fluorescent lamps such as CCFLs (cold cathode fluorescent lamps), HCFLs (hot cathode fluorescent lamps), and EEFLs (external electrode fluorescent lamps). One-dimensional dimming can be implemented in displays backlit by LED light sources by using the light emitting blocks shown in FIGS. 24 through 26. One-dimensional dimming is possible when the LED light sources in each light emitting block can be addressed independently of the LED light sources in the other light emitting blocks. Furthermore, two-dimensional dimming can be implemented in displays backlit by LED light sources by using the light emitting blocks shown in FIG. 24. Note that two-dimensional dimming is not possible with the conventional light emitting assembly 100 shown in FIG. 1. Two-dimensional dimming is suitable for displays backlit using LEDs or OLEDs.

Adaptive backlight boosting is another technique that can be implemented in 0-D, 1-D, and 2-D configurations. In adaptive backlight boosting, the effective intensity of the backlighting is increased in response to a video data signal representing a high image intensity such that the displayed image intensity is increased. The effective intensity of the backlighting can be increased by increasing a current drive, a voltage drive, a current pulse duty cycle, a voltage pulse duty cycle or another suitable drive parameter applied to the LED light sources optically coupled to the respective light emitting block. Adaptive backlight boosting is implemented in combination with adaptive backlight dimming because it takes advantage of the margin (e.g., electrical power and system temperature) provided by adaptive dimming. The perceived contrast and brightness can be increased. For more information on adaptive dimming and boosting, refer to: P. de Greef, et al., Adaptive Scanning, 1-D Dimming, and Boosting Backlight for LCD-TV Systems, 14 J. OF THE SID, 1103-1110 (2006) and T. Shiga, et al., Power Saving and Enhancement of Gray-Scale Capability of LCD TVs with an Adaptive Dimming Technique, 16 JOURNAL OF THE SID, 311-316 (2008).

Because of the slow response of nematic liquid crystal materials to an applied driving voltage, moving objects can appear to have blurred edges. Impulse driving, which can be realized with scanning backlighting, can improve this aspect of image quality. Backlight scanning is synchronized to the row scanning of the LCD panel. The pixels in a region of the LCD panel corresponding to each light emitting block are illuminated by the light emitting block only after the liquid crystal material therein have reached or exceeded a defined optical response level.

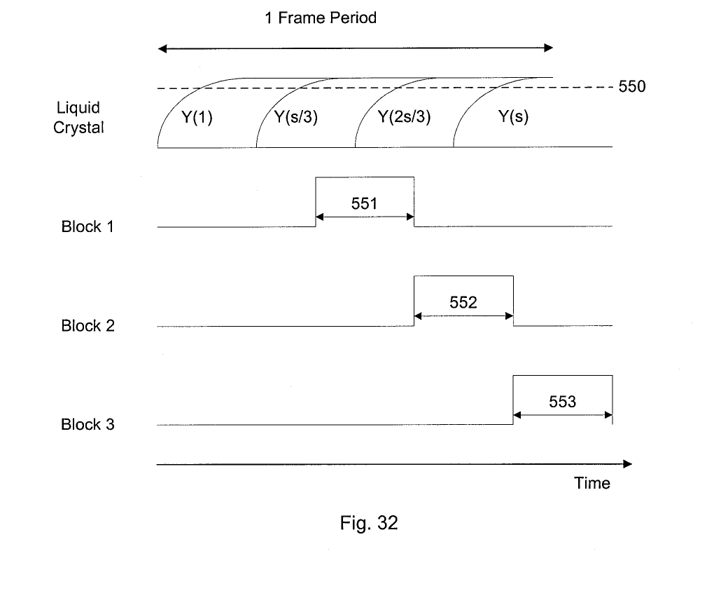

An example of impulse driving will now be described with reference to FIGS. 29, 30, and 32. As described above, the portion of LCD panel 502 including row lines Y(1) through Y(s/3) is illuminated by light emitting block 531, the portion including row lines Y(s/3+1) through Y(2s/3) is illuminated by light emitting block 532, and the portion including row lines Y(2s/3+1) through Y(s) is illuminated by light emitting block 533. FIG. 32 is a schematic timing chart showing the optical response of the liquid crystal material at various locations (row lines) in the LCD panel and the timing of the illumination provided by light emitting blocks 531-533. The row select signals are sequentially imposed on row lines Y(1) through Y(s) starting at row line Y(1) and ending at row line Y(s).

FIG. 39 also shows representative temporal response curves for pixels whose pixel circuits are attached to row lines Y(1), Y(s/3), Y(2s/3), and Y(s), respectively. Light emitting block 531 is turned on during illumination period 551, which begins only after the liquid crystal material of the pixels whose pixel circuits are attached to row lines Y(1) through Y(s/3) have reached or exceeded the desired optical response level 550. Similarly, light emitting block 532 is turned on during illumination period 552, which begins only after the liquid crystal material of the pixels whose pixel circuits are attached to row lines Y(s/3+1) through Y(2s/3) have reached or exceeded the desired optical response level 550. Finally, light emitting block 533 is turned on during illumination period 553, which begins only after the liquid crystal material of the pixels whose pixel circuits are attached to row lines Y(2s/3+1) through Y(s) have reached or exceeded the desired optical response level 550.

However, with impulse driving, image flicker may become visible in bright images. To reduce the image flicker, a second light pulse per frame can be added, resulting in 50 (for 25 frame-per-second video signals) or 60 (for 30 frame-per-second video signals) light pulses per second. In this case, dual illumination pulses reduce the perception of image flicker because the human eye functions as a temporal low-pass filter. However, double edges can become visible in moving images with dual-pulse illumination.

Adaptive dual pulse backlighting has been developed to provide a balance between the need to reduce image flicker in bright images and the need to reduce double edges in moving images. Adaptive dual pulse illumination can be implemented in 0-D, 1-D, and 2-D configurations. As in adaptive dimming and boosting, 2-D adaptive dual pulse illumination can be implemented with an array of individually controllable light emitting blocks. For bright images with little motion where flicker reduction is important, the backlight is operated in a dual pulse mode. For moving images where the scene is not bright, double edges are eliminated by operating the backlight in a single pulse mode. Transitions between the single pulse and dual pulse modes can be implemented by gradually changing the phase, the pulse-width, or the intensity of the second pulse relative to the first pulse. Furthermore, in scenes including some motion and some brightness, an interpolation of the single pulse and dual pulse modes is used. Two-dimensional adaptive dual pulse illumination is useful because the interpolation between single pulse and dual pulse modes can be optimized for each independently controllable light emitting region. For more information on adaptive pulse driving, refer to P. de Greef, et al., Adaptive Scanning, 1-D Dimming, and Boosting Backlight for LCD-TV Systems, 14 J. OF THE SID, 1103-1110 (2006).

This disclosure describes the invention in detail using illustrative embodiments. However, the invention defined by the appended claims is not limited to the precise embodiments described.

We claim:

1. A light emitting assembly, comprising:
a planar optical conductor having a major surface and comprising a light input surface, the optical conductor characterized by a length and a width;
a light emitting diode (LED) light source, the LED light source being small relative to the length and width of the optical conductor and located adjacent the light input surface such that light emitted by the LED light source is incident on the light input surface;
a pattern of well defined optical elements on or in the optical conductor, the optical elements configured to direct the light from the LED light source out from the major surface of the optical conductor, the optical elements additionally configured to define elongate higher brightness regions and a lower brightness region outside the higher brightness regions; and
an optical film, sheet, or substrate located to receive the light emitted from the optical conductor.

2. The light emitting assembly of claim 1, wherein:
the LED light source is configured to generate light having an output distribution characterized by a greater width component than height component, and
the height component of the output distribution is substantially orthogonal to the major surface of the optical conductor.

3. The light emitting assembly of claim 1, wherein the higher brightness regions comprise a first higher brightness region separated from a second higher brightness by a first portion of the lower brightness region, and a third higher brightness region separated from the second higher brightness region by a second portion of the lower brightness region.

4. The light emitting assembly of claim 3, wherein the higher brightness regions are nominally parallel to one another and are approximately equally spaced from one another.

5. The light emitting assembly of claim 3, wherein:
the LED light source is a first LED light source and the light emitting assembly additionally comprises a second LED light source;
the first LED light source is located closer to the first higher brightness region than to the second and third higher brightness regions; and
the second LED light source is located closer to the third higher brightness region than to the first and second higher brightness regions.

6. The light emitting assembly of claim 5, wherein the first LED light source is located adjacent a first corner of the optical conductor and the second LED light source is located adjacent a second corner of the optical conductor, the second corner diagonally opposite the first corner.

7. The light emitting assembly of claim 1, wherein each of the higher brightness regions is nominally rectangular in shape.

8. The light emitting assembly of claim 1, wherein each of the higher brightness regions extends nominally parallel to the length or width of the optical conductor.

9. The light emitting assembly of claim 1, wherein the optical conductor is nominally rectangular in shape.

10. The light emitting assembly of claim 1, wherein the higher brightness regions are nominally parallel to the light input surface.

11. The light emitting assembly of claim 1, wherein the higher brightness regions are nominally orthogonal to the light input surface.

12. The light emitting assembly of claim 1, wherein the LED light source is located adjacent a corner of the optical conductor.

13. The light emitting assembly of claim 1, wherein the LED light source is located offset from a side of the optical conductor.

14. The light emitting assembly of claim 1, wherein the higher brightness regions are oriented at an oblique angle to the LED light input surface.

15. The light emitting assembly of claim 1, additionally comprising a lens array on at least one of the LED light source and the light input surface.

16. The light emitting assembly of claim 1, wherein the optical sheet, film, or substrate is separated from the optical conductor by an air gap.

17. The light emitting assembly of claim 1, wherein the optical sheet, film, or substrate comprises a pattern of well defined optical elements such that the light emitted from the optical conductor has a more uniform brightness after passing through the optical sheet, film, or substrate.

18. The light emitting assembly of claim 1, wherein the optical sheet, film, or substrate has a pattern of well defined optical elements such that the light emitted from the optical conductor has a direction closer to a normal to the major surface of the optical conductor after passing through the optical sheet, film, or substrate.

19. The light emitting assembly of claim 1, additionally comprising a light source housing defined in the optical conductor in which the LED light source is mounted.

20. A liquid crystal display apparatus, comprising a liquid crystal display panel and the light emitting assembly of claim 1, wherein the light emitting assembly illuminates the liquid crystal display panel.

21. A light emitting assembly, comprising:
a generally planar optical conductor having a major surface and comprising light input surfaces, the optical conductor characterized by a length and a width;
light emitting diode (LED) light sources located along a virtual line, each one of the LED light sources being small relative to the length and width of the optical conductor and located adjacent a corresponding one of the light input surfaces such that light emitted by the one of the LED light sources is incident on the corresponding one of the light input surfaces;
a pattern of well defined optical elements on or in the optical conductor, the optical elements configured to redirect the light from the light sources out from the optical conductor, the optical elements configured to define elongate higher brightness regions nominally parallel to the virtual line, and a lower brightness region outside the higher brightness regions; and
an optical film, sheet, or substrate located to receive light emitted from the optical conductor.

22. The light emitting assembly of claim 21, wherein:
the light sources are each to generate light having an output distribution defined by a greater width component than height component, and
the height component of the output distribution is nominally orthogonal to the major surface of the optical conductor.

23. The light emitting assembly of claim 21, wherein the higher brightness regions extend nominally along the length or width of the optical conductor.

24. The light emitting assembly of claim 21, wherein the optical conductor is substantially rectangular in shape.

25. The light emitting assembly of claim 21, wherein the optical elements have one or more of an area density, number density, size, depth, and height that varies within at least one of the higher brightness regions.

26. The light emitting assembly of claim 21, wherein the optical elements have at least one of an area density, number density, size, depth, and height in at least one of the higher brightness regions that is greatest at a location that is approximately halfway between the LED light sources.

27. The light emitting assembly of claim 21, wherein the higher brightness regions are nominally parallel to the light input surfaces.

28. The light emitting assembly of claim 21, wherein the higher brightness regions are oriented at an oblique angle to the light input surfaces.
